(19) United States
(12) Patent Application Publication
(10) Pub. No.: US 2005/0012700 A1
(43) Pub. Date: Jan. 20, 2005

(54) Gamma correction circuit, liquid crystal driving circuit, display and power supply circuit

(76) Inventor: Taro Hara, Chino-shi (JP)

Correspondence Address: HARNESS, DICKEY & PIERCE, P.L.C., P.O. BOX 828, BLOOMFIELD HILLS, MI, 48303, US

(21) Appl. No.: 10/869,056

(22) Filed: Jun. 16, 2004

(30) Foreign Application Priority Data
Jun. 17, 2003 (JP) 2003-172104

(51) Int. Cl. G09G 3/36

(52) U.S. Cl. 345/89

(57) ABSTRACT

A gamma correction circuit is provided. Gamma correction resistors on an input side are coupled to each other in series between input voltages. The gamma correction resistors around the input voltages are variable resistors and the other resistors are fixed resistors. Gamma correction resistors on an output side are coupled to each other in series between the input voltages. The gamma correction resistors in the vicinity of the input voltages are variable resistors and the other resistors are fixed resistors. When the setting of gray scale voltages is changed by changing the gamma correction resistors on the input side, the gamma correction resistors on the output side are simultaneously changed. Thereby, the potentials of an input side and output side of an operational amplifier are kept identical to each other such that overcurrent does not flow between the gamma correction resistor and the operational amplifier.

### RELATED APPLICATIONS

This application claims priority to Japanese Patent Application No. 2003-172104 filed Jun. 17, 2003 which is hereby expressly incorporated by reference herein in its entirety.

### BACKGROUND

1. Field of the Invention

The present invention relates to a gamma correction circuit in a display. More specifically, the invention relates to a gamma correction circuit (y correction circuit) producing gray scale voltage corresponding to the gamma characteristic of a display.

2. Description of Related Art

In recent years, as displays such as a liquid crystal display and a CRT display spread, the displays are required to have further improved display quality, a higher resolution, and a larger capacity.

Generally, displays such as a liquid crystal display and a CRT display each have a specific gamma characteristic such that inputs (input voltage, an input signal, etc.) and outputs (gray scale, optical transparency, brightness, etc.) do not have a straight directly proportional relationship but an exponential relationship. Thus, displays output after implementing a gamma correction for inputs to make inputs and outputs have a straight directly proportional relationship so as to accurately reproduce images based on display data.

Liquid crystal displays can be classified roughly into a passive matrix liquid crystal display, and an active matrix liquid crystal display, each of which realizes gray scale display by gray scale control different from each other.

In a passive matrix liquid crystal display, intersection points of stripe upper and lower electrodes opposed to each other with liquid crystal therebetween are controlled in a matrix as each pixel and thus realizing display. Thus, although the structure is simple, cross talk due to leakage of charges from the adjacent pixels is caused, and there is a limitation in increasing resolution and data amount of display.

In addition, with respect to gray scale control in a passive matrix liquid crystal display, gray scale control by each pixel is difficult because of the structure thereof. Accordingly, FRC (Frame Rate Control) in which a plurality of frame periods is defined as one display period and multilevel gray scale is realized utilizing the ratio of times of ON and OFF, and dithering (area gray scale display) in which one display gray scale is realized with a plurality of display pixels are adopted. These methods, however, are not suitable for increasing resolution and gray scale of display images.

Meanwhile, an active matrix liquid crystal display hardly involves cross talk and is suitable for increasing resolution and data amount of display since each pixel is controlled independently with a switching element such as a TFT (Thin Film Transistor). This active matrix type therefore is the mainstream today.

In addition, with respect to gray scale control in an active matrix liquid crystal display, charges can be controlled for each pixel unit independently such that multilevel gray scale display can be realized by applying voltage corresponding to gray scale to pixel electrodes.

FIG. 12 is a diagram indicating the gamma characteristic (optical transparency characteristic of liquid crystal) of a liquid crystal display.

A gamma correction curve 1201 shown in FIG. 12 relates to a normally-white active matrix liquid crystal display.

In the gamma correction curve 1201, the relationship between the voltage (Vx) applied to liquid crystal and the gray scale (x) indicating brightness of display is non-linear. Accordingly, to accurately reproduce images based on display data, a voltage needs be applied to the liquid crystal after implementing a gamma correction.

For example, in an active matrix liquid crystal display having the gamma characteristic shown in FIG. 12, when displaying at gray scale “2”, voltage “V2” applied to the liquid crystal is selected and applied to a liquid crystal driving circuit (a source driver and so on). When displaying at gray scale “61”, voltage “V61” applied to the liquid crystal is selected and applied to a liquid crystal driving circuit (a source driver and so on).

In an active matrix liquid crystal display, a gamma correction circuit and the like is provided to implement gamma correction treatment (refer to Japanese Unexamined Patent Publication No. 2003-22062 (FIG. 7) and Japanese Unexamined Patent Publication No. 2003-22063 (FIG. 7) for example).

A conventional gamma correction circuit will be described with reference to FIG. 11.

FIG. 11 is a diagram showing a conventional gamma correction circuit 1100.

The gamma correction circuit 1100 is provided in a liquid crystal driving circuit (a source driver and so on) of an active matrix liquid crystal display (it is explained on the premise that 64 (sixty-four) gray scale display (6 bit) is used for each pixel). The gamma correction circuit 1100 produces standard gray scale voltages VREF (VREF1 through VREF9) from input voltage difference (|VDDR−VSS|) and produces gray scale voltages Vx (V0 through V63) from standard gray scale voltage difference (|VREF1−VREF2|). The gamma correction circuit 1100 functions as a gray scale voltage producing circuit (multivalued voltage producing circuit).

An active matrix liquid crystal display selects applied voltage (gray scale voltage) for each pixel based on the gray scale indicated by display data and apply it.

In the gamma correction circuit 1100, gamma correction resistors 1101 (rP1 through rP8) are coupled to each other in series between the input voltages (between VDDR and VSS). Similarly, gamma correction resistors 1103 (rQ1 through rQ63) are coupled to each other in series between the input voltages (between VDDR through VSS). As shown in FIG. 11, the gamma correction resistors 1101 (rP) are provided on an input side of the gamma correction circuit. The gamma correction resistors 1103 (rQ) are provided on an output side of the gamma correction circuit.

The gamma correction resistors 1101 (rP1 through rP8) are variable resistors, and the gamma correction resistors 1103 (rQ1 through rQ63) are fixed resistors. The resistance value of the gamma correction resistors 1101 (rP1 through rP8), which are variable resistors, can be adjusted with correction signals 1104 (P1 through P8).

Each operational amplifier 1102 is provided between one of the nodes 1111 of the resistors 1101 (rP) and one of the nodes 1113 of the resistors 1103 (rQ) corresponding to the resistors 1101 (rP). The operational amplifiers 1102 function as a voltage follower performing impedance conversion and prevents voltage drop due to current supply when a gray scale voltage is applied to the pixel.

The initial resistance value (default or standard resistance value) of the gamma correction resistors 1101 (rP) and the resistance value of the gamma correction resistors 1103 (rQ) are determined depending on the gamma characteristic of the active matrix liquid crystal display. In this case, the resistance values between the same standard gray scale voltages are determined to be identical to each other. For example, between the standard gray scale voltages REF1 and REF2 (V0 and V2), (initial resistance value of rP1)=(resistance value of rQ1)+(resistance value of rQ2) is satisfied.

The gamma correction circuit 1100 produces the standard gray scale voltages VREF (VREF1 through VREF9) from the input voltages (VDDR and VSS) input from a power supply circuit for each of the nodes 1111 of the gamma correction resistors 1101 (rP) so as to produce the gray scale voltages Vx (V0 through V63) for each of the nodes 1113 of the gamma correction resistors 1103 (rQ).

The case where the gamma correction circuit shown in FIG. 11 is used for liquid crystal displays having different characteristics will be described with reference to FIG. 13.

FIG. 13 is a diagram indicating the gamma characteristic (optical transparency characteristic of the liquid crystal) of a liquid crystal display A and a liquid crystal display B.

A gamma correction curve 1301 indicates the gamma characteristic of the liquid crystal display A (default), and a gamma correction curve 1302 indicates the gamma characteristic of the liquid crystal display B.

In the case where the gamma correction circuit 1100 constituted based on the gamma characteristic of the liquid crystal display A is used for the liquid crystal display B, the setting of the gray scale voltage output from the gamma correction circuit 1100 needs be changed since the liquid crystal displays A and B have different gamma characteristics.

Thus, the resistance values of the gamma correction resistors 1100 (rP) are changed with the correction signals 1104 (P) based on the gamma correction curve 1302 so as to change the standard gray scale voltages VREF (VREF1 through VREF9), and thereby the gray scale voltages Vx (V0 through V63) are changed.

For example, the resistance value of the gamma correction resistor rP8 is changed with the correction signal P8 based on the gamma correction curve 1302 such that the standard gray scale voltage VREF8 is changed from V61A to V61B.

As described above, a conventional gamma correction circuit changes the setting of the gray scale voltage by changing the ratio of gamma correction resistance on an input side so as to change the standard gray scale voltage VREF. In this case, the ratio of gamma correction resistance on an output side is not changed since the gamma correction resistors on an output side are fixed resistors.

Accordingly, a potential difference is caused between the node of the gamma correction resistor on an input side and the node of the corresponding gamma correction resistor on an output side, causing a current between the gamma correction resistor on an output side and an operational amplifier. Namely, in the case where the same gamma correction circuit is used for a liquid crystal display having a different gamma characteristic, the ratio of gamma correction resistance on an input side needs be changed for the difference in a gamma characteristic and thus causing a problem that a current is generated between the gamma correction resistor and the operational amplifier.

For example, in the case where the gamma correction circuit 1100 is mounted in a liquid crystal display having a default gamma characteristic in FIG. 11, (initial resistance value of rP1)=(resistance value of rQ1)+(resistance value of rQ2) is satisfied. Meanwhile, in the case where the gamma correction circuit 1100 is mounted in a liquid crystal display having a gamma characteristic different from the default, since the ratio of gamma correction resistance on an input side is changed by changing the gamma correction resistor rP1, (resistance value of rP1 after change)<(resistance value of rQ1)+(resistance value of rQ2), or (resistance value of rP1 after change)>(resistance value of rQ1)+(resistance value of rQ2) is satisfied. As a result, a potential difference is caused between the node 1111 and the node 1113 such that a current 1112 is generated.

Furthermore, in the case where a potential difference is caused between the node of the gamma correction resistor on an input side and the node of the corresponding gamma correction resistor on an output side such that a current is generated between the gamma correction resistor on an output side and the operational amplifier, there is a problem that a stable gray scale voltage can not be supplied since the operational amplifier may oscillate.

There is also a problem that power consumption is increased because of overcurrent. For example, in the case of a liquid crystal display driven with a battery, there is a problem that driving time (time when display is possible) becomes short.

In recent years, there has been a trend where current consumption in a driver IC for driving a liquid crystal display increases as a display capacity of a liquid crystal display increases. However, the increase in current consumption is not allowed even if display capacity is increased. On the contrary, the trend is toward demands for lower power consumption. This demand for lower power consumption is especially prominent in mobile apparatuses such as a cellular phone and a portable information terminal.

In view of the above problems, the present invention is intended to provide a gamma correction circuit that can be compatible with various gamma characteristics and can supply a stable gray scale voltage while suppressing power consumption.

### SUMMARY

In order to achieve the above, a first aspect of the invention is a gamma correction circuit dividing input voltage so as to produce a plurality of standard gray scale voltages, and further dividing the standard gray scale voltages so as to output a plurality of gray scale voltages. The gamma correction circuit comprises: a plurality of first resistors producing the standard gray scale voltages at each of the nodes and including at least one variable resistor; a plurality of second resistors producing the gray scale voltages at each of the nodes and including at least one variable resistor; and at least one voltage follower outputting the standard gray scale voltages input from a side of the first resistors to a side of the second resistors.

The gamma correction circuit supplies the gray scale voltage to an output circuit that converts display data into driving voltage so as to output it to a display (various display devices and so on).

The first resistors are gamma correction resistors on an input side. The first resistors are coupled to each other in series between a high potential side of the input voltage and a low potential side of the input voltage and divide the input voltage so as to produce the standard gray scale voltage from the node.

The second resistors are gamma correction resistors on an output side. The second resistors are coupled to each other in series between the standard gray scale voltages and divide the standard gray scale voltage so as to produce the gray scale voltage from the node.

The voltage follower is made up of an operational amplifier and so on, and implements impedance conversion. The voltage follower outputs the standard gray scale voltage input from a side of the first resistors to a side of the second resistors.

It is preferable that the first resistors and the second resistors that are provided between the same standard gray scale voltages are both variable resistors, or are both fixed resistors.

In addition, preferably, the variable resistors are controlled so that the resistance value of the first resistors and the resistance value of the second resistors are identical to each other between the same standard gray scale voltages, and then fixed resistors are determined.

The gamma correction circuit of the first aspect of the invention controls variable resistors so that the resistance value of the first resistors and the resistance value of the second resistors are identical to each other between the same standard gray scale voltages, in the case where the gamma correction circuit is used for a display having a different gamma characteristic.

The gamma correction circuit of the first aspect of the invention changes the setting of the gray scale voltage by changing the ratio of gamma correction resistance on an input side and the ratio of gamma correction resistance on an output side simultaneously. Thus, overcurrent does not flow between the gamma correction resistor and the operational amplifier since the potentials of an input side and output side of the operational amplifier are invariably kept be identical to each other.

Accordingly, oscillation of the operational amplifier is prevented such that the stable gray scale voltage can be supplied. In addition, power consumption can be suppressed.

The first resistors and the second resistors in the vicinity of the input voltage (around edge gray scale) may be variable resistors, and the remaining first and second resistors may be fixed resistors.

Since the gamma correction curve around the intermediate gray scale voltage is more linear (straight line manner) compared to that around the edge gray scale voltage (in the vicinity of input voltage), only the resistors around edge gray scale voltage (in the vicinity of input voltage) are variable resistors. Only the setting of the gray scale voltage that is a non-linear part is changed corresponding to a new gamma characteristic, and thereby the setting of a gray scale voltage that is a linear part is also changed along with the new gamma characteristic. Namely, the ratio of gamma correction resistance around the intermediate gray scale, where a gamma characteristic is linear, need not be changed. In this case, the circuit arrangement can be simplified compared to the case where all of the gamma correction resistors are variable resistors. Accordingly, a cost burden and labor burden of manufacturing can be reduced.

Furthermore, in a power supply circuit including a boosting circuit, a voltage regulator, and so on, an input voltage other than the input voltage for voltage dividing may be produced as with the input voltage for voltage dividing, and at least one short circuit where the input voltage other than the input voltage for voltage dividing is used as the standard gray scale voltage or the gray scale voltage may be provided.

In this case, since the settings of the standard gray scale voltage and the gray scale voltage can be changed by changing the input voltage by the power supply circuit, there is no need to change the structure of the gamma correction circuit itself.

The variable resistor may be made up of a resistor for selection, a resistor selection circuit, and the like. As the resistor selection circuit, an analogue switch and so on whose ON and OFF are controlled with a correction signal can be used.

A second aspect of the invention is a liquid crystal driving circuit comprising the gamma correction circuit of the first aspect of the invention.

A third aspect of the invention is a display comprising the gamma correction circuit of the first aspect of the invention.

The display can be various displays performing gray scale display. These displays include a liquid crystal display, a plasma display panel (PDP), an EL display (Electro Luminescent Display), and an electronic paper display, a CRT display, and so on.

A fourth aspect of the invention is a power supply circuit producing the gray scale voltage for selection throughout all gray scales and supplying the gray scale voltage to an output circuit that digital to analog (D/A) converts display data so as to output driving voltage to an electrode (a source electrode and so on).

In the fourth aspect of the invention, instead of dividing the voltage in a gamma correction circuit, all of the gray scale voltages are produced based on a gamma characteristic.

In this case, the gamma correction circuit need not necessarily be provided.

A fifth aspect of the invention is a liquid crystal driving circuit comprising the power supply circuit of the fourth aspect of the invention.

A sixth aspect of the invention is a display comprising the power supply circuit of the fourth aspect of the invention.

### BRIEF DESCRIPTION OF THE DRAWINGS

FIG. 1 is a diagram schematically showing the structure of a display 100 where a gamma correction circuit is provided.

FIG. 2 is a diagram schematically showing the structure of a power supply circuit 200.

FIG. 3 is a diagram showing the schematic structure and schematic operation of a source driver 104.

FIG. 4 is a diagram showing the structure of a gamma correction circuit 400 according to an embodiment of the present invention.

FIG. 5 is a diagram showing one embodiment of a variable resistor 500.

FIG. 6 is a diagram schematically showing the structure of a power supply circuit 600 according to another embodiment.

FIG. 7 is a diagram schematically showing the structure of a gamma correction circuit 700 according to another embodiment.

FIG. 8 is a diagram schematically showing the structure of a gamma correction circuit 800 according to another embodiment.

FIG. 9 is a diagram schematically showing the structure of a gamma correction circuit 900 according to another embodiment.

FIG. 10 is a diagram schematically showing the structure of a gamma correction circuit 1000 according to another embodiment.

FIG. 11 is a diagram showing a conventional gamma correction circuit 1100.

FIG. 12 is a diagram indicating the gamma characteristic (optical transparency characteristic of liquid crystal) of a liquid crystal display.

FIG. 13 is a diagram indicating the gamma characteristic (optical transparency characteristic of liquid crystal) of a liquid crystal display A and a liquid crystal display B.

FIG. 14 is a diagram showing one embodiment of a gamma correction circuit 1400 outputting gray scale voltages of two sets.

FIG. 15 is a diagram showing one embodiment of a power supply circuit 1500 producing all gray scale voltages.

### DETAILED DESCRIPTION

Preferred embodiments of a gamma correction circuit according to the present invention will be described below in detail with reference to accompanying drawings. In the following description and accompanying drawings, the same numerals are given to structural elements having substantially the same function and structure and overlapping explanation will be omitted.

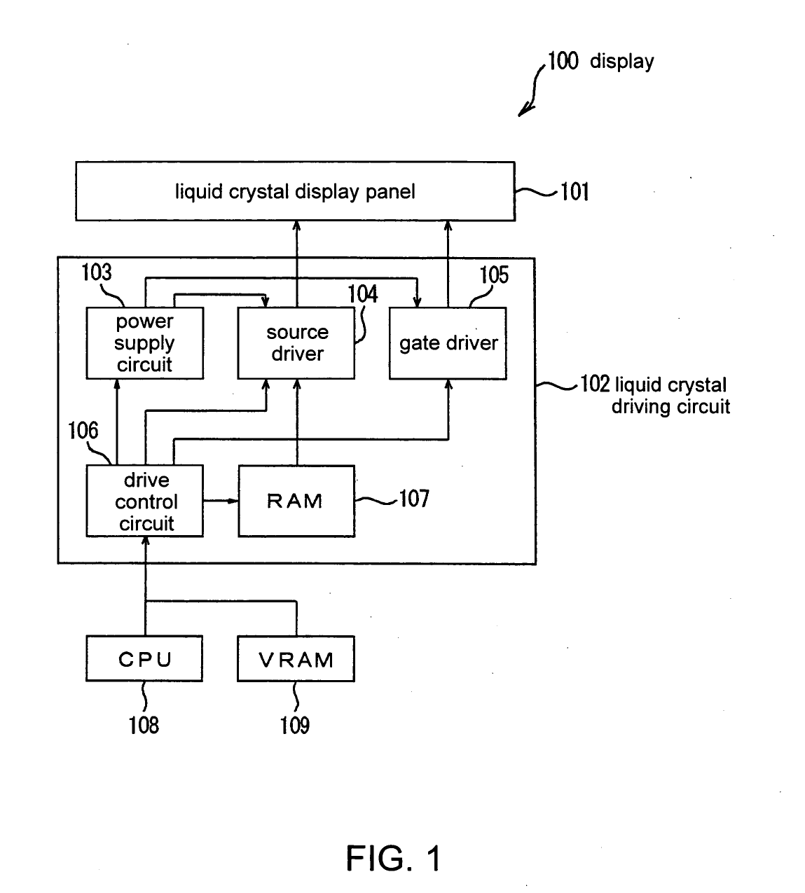

First, the schematic structure of a display for which a gamma correction circuit is provided will be described with reference to FIG. 1.

FIG. 1 is a diagram schematically showing the structure of a display 100 for which a gamma correction circuit is provided.

The display 100 comprises a liquid crystal display panel 101 and a liquid crystal driving circuit 102. The devices are coupled to each other with a system bus.

The display 100 is coupled to a CPU 108 and a VRAM 109 (Video RAM) with a system bus, various cables, wireless communication, and so on.

The liquid crystal display panel 101 is an active matrix LCD display, where electrodes along the vertical direction (source electrodes) and electrodes along the horizontal direction (gate electrodes) are arranged for pixels (liquid crystal display elements) arranged in a lattice. Each pixel includes a switching element such as a TFT (Thin Film Transistor) such that each pixel is controlled independently.

The liquid crystal driving circuit 102 is a device such as an IC and an LSI that drives pixels of the liquid crystal display panel 101 so as to perform bit map display. Into the liquid crystal driving circuit 102, a power supply circuit 103, a source driver 104, a gate driver 105, a drive control circuit 106, and a display RAM 107 are incorporated.

When the liquid crystal driving circuit 102 receives a control signal and display data from the CPU 108 and the VRAM 109, the liquid crystal driving circuit 102 supplies voltage to the source electrode and gate electrode of the liquid crystal display panel 101 based on the control signal and display data. The liquid crystal driving circuit 102 applies voltage for controlling ON and OFF of the switching element to the gate electrode, and applies voltage (gray scale voltage) for gray scale display to the source electrode, so as to drive each pixel.

The power supply circuit 103 implements boosting, regulating, and so on, and supplies voltage to the source driver 104 and the gate driver 105.

The source driver 104 produces gray scale voltage from voltage supplied from the power supply circuit 103 after implementing gamma correction and then selects the gray scale voltage to be applied based on a control signal and display data sent from the drive control circuit 106 and the RAM 107 so as to supply the gray scale voltage to the source electrode of the liquid crystal display panel 101.

The gate driver 105 supplies a gate voltage to the gate electrode of the liquid crystal display panel 101 based on a control signal sent from the drive control circuit 106.

The drive control circuit 106 outputs a control signal for controlling the source driver 104 and the gate driver 105.

The RAM temporarily retains display data for each pixel input from the CPU 108 and the VRAM 109.

The CPU 108 and the VRAM 109 are provided in an apparatus such as a computer.

The display 100 is used as, for example, a display medium for picture images, video images, characters, and so on. The display 100 and an apparatus including the CPU 108, the VRAM 109, and so on (a portable information terminal, a cellular phone, a notebook computer, a digital camera, and so on) may be combined integrally.

The liquid crystal display panel 101, the liquid crystal driving circuit 102, and so on may be independent from each other, or may be provided on the same substrate in a manner of being integrated with each other.

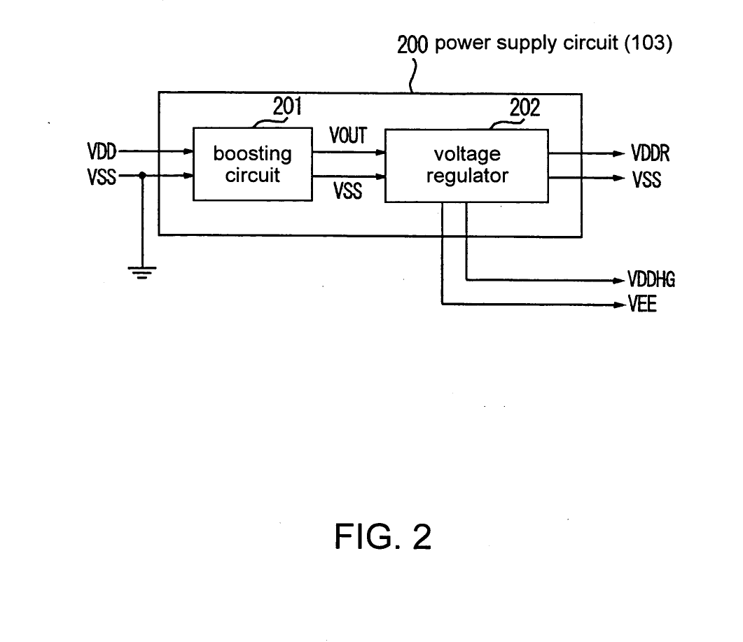

The schematic structure of a power supply circuit 200 (103) will be described with reference to FIG. 2.

FIG. 2 is a diagram schematically showing the structure of the power supply circuit 200.

The power supply circuit 200 comprises a boosting circuit 201 and a voltage regulator 202.

The boosting circuit 201 boosts system supply voltage VDD so as to output boosted voltage VOUT.

The high and low potential side voltage of the system supply voltage is VDD and VSS, respectively. The low potential side voltage VSS may be coupled to ground.

The voltage regulator 202 implements regulating when boosted voltages VOUT and VSS are input thereto so as to supply the voltages VDDR and VSS to a gamma correction resistor (to be described later) of a gamma correction circuit (to be described later), and supply the gate voltages VDDHG and VEE to the gate driver 105.

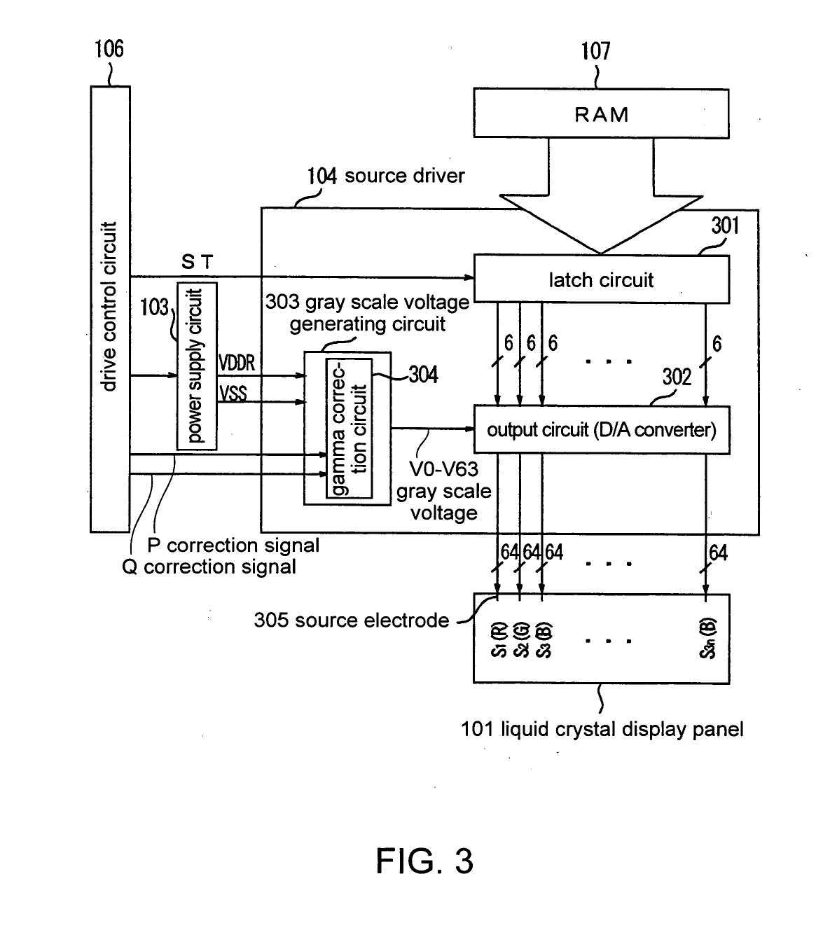

The schematic structure and schematic operation of the source driver 104 will be described with reference to FIG. 3.

FIG. 3 is a diagram showing the schematic structure and schematic operation of the source driver 104.

The explanation will be made on the premise that display data sent from the drive control circuit 106 to the source driver 104 via the RAM 107 have 6 (six) bits of data for each of three pixel components (R, G, and B). Furthermore, the explanation will be made on the premise that the liquid crystal display panel 101 includes pixels of n×3 (R, G, and B) rows and n×3 source electrodes.

The source driver 104 comprises a latch circuit 301, an output circuit 302 (D/A converter), a gray scale voltage generating circuit 303 and a gamma correction circuit 304.

The latch circuit 301 reads display data from the RAM 107 and latches them in synchronization with a strobe signal (ST). The display date is converted into voltage by the output circuit 302 so as to be output to the source electrodes (S₁ (R), S₂ (G), S₃ (B), through S₃ₙ₋₂ (R), S₃ₙ₋₁ (G), and S₃ₙ (B)).

The gray scale voltage generating circuit 303 produces gray scale voltages (V0 through V63) of 64 (sixty-four) kinds (6 bits) from the input voltages (VDDR and VSS) input from the power supply circuit 103, by the gamma correction circuit 304, so as to supply the gray scale voltages to the output circuit 302. Each gray scale voltage corresponds to any of the 64 (sixty four) gray scales (6 bits) which a pixel can assume.

In the gamma correction circuit 304, the gamma correction resistors are arranged so that gray scale voltage accords with the default gamma characteristic. Meanwhile, in the case of a different gamma characteristic, the resistance value and the resistance ratio of the gamma correction resistors are changed with correction signals (P and Q) so that the gray scale voltage accords with the different gamma characteristic.

The output circuit 302 selects the gray scale voltage (V0 through V63) corresponding to display data by the D/A converter and an analog switch based on display data sent from the latch circuit 301 so as to supply the gray scale voltage to the source electrode 305.

When the gray scale voltage is output to the source electrode, impedance conversion may be implemented.

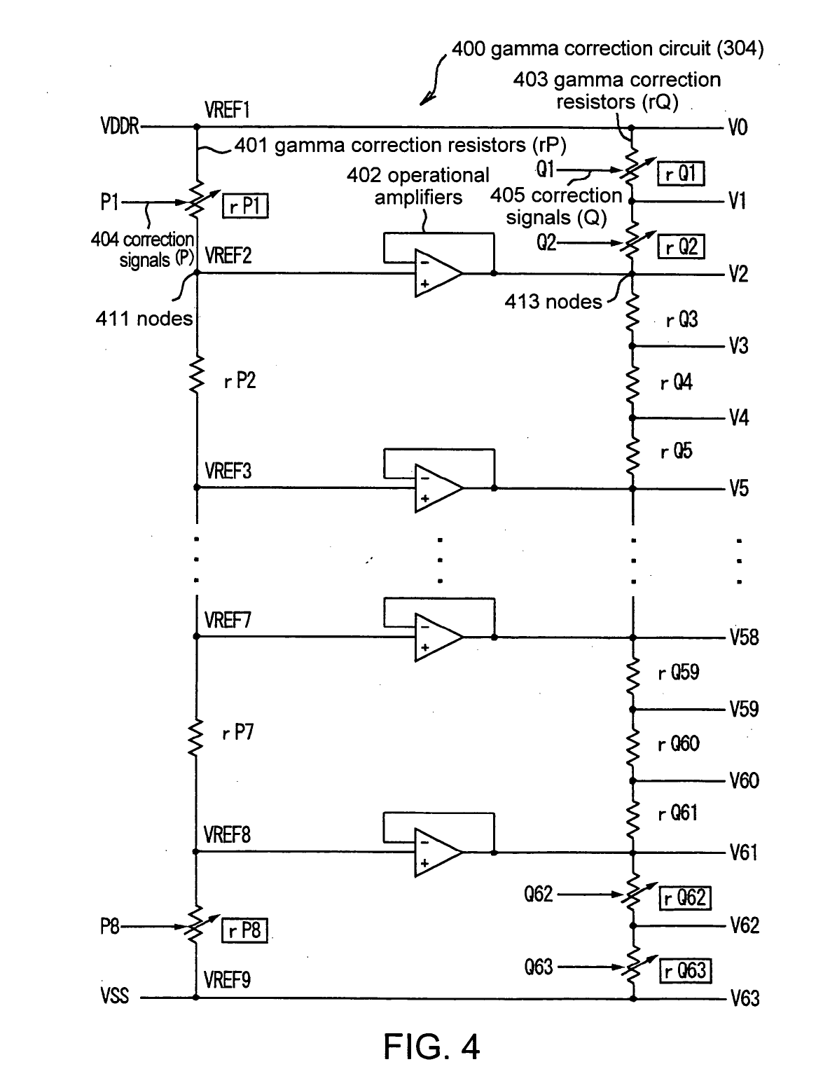

The structure and operation of a gamma correction circuit 400 (304) according to embodiments of the invention will be described with reference to FIG. 4.

FIG. 4 is a diagram showing the structure of the gamma correction circuit 400.

A plurality of gamma correction resistors 401 (rP1 through rP8) on an input side, a plurality of gamma correction resistors 403 on an output side and a plurality of operational amplifiers 402 are coupled to each other, and thereby the gamma correction circuit 400 is constituted.

The explanation will be made on the premise that the gamma correction circuit 400 produces the standard gray scale voltages VREF (VREF1 through VREF9) from the input voltages (VDDR and VSS) input from the power supply circuit 103 for each of the nodes 411 of the gamma correction resistors 401 (rP1 through rP8) on an input side, and further produces the gray scale voltages Vx (V0 through V63) for each of the nodes 413 of the gamma correction resistors 403 (rQ1 through rQ63) on an output side.

The gamma correction resistors 401 on an input side are coupled to each other in series between the two input voltages (VDDR and VSS).

Some of the gamma correction resistors 401 that are in the vicinity of the input voltages (VDDR and VSS) are variable resistors that can control the resistance value with a correction signal 404 (P). The remaining gamma correction resistors 401 are fixed resistors.

Referring to FIG. 4, the gamma correction resistors rP1 and rP8 are variable resistors that can control the resistance value with the correction signals P1 and P8. The gamma correction resistors rP2 through rP7 are fixed resistors.

The gamma correction resistors 403 on an output side are coupled to each other in series between the two input voltages (VDDR and VSS).

Some of the gamma correction resistors 403 that are in the vicinity of the input voltages (VDDR and VSS) are variable resistors that can control the resistance value with a correction signal 405 (Q). The remaining gamma correction resistors 403 are fixed resistors.

Each of the nodes of the gamma correction resistors 403 on an output side outputs the gray scale voltage (V0 through V63).

Referring to FIG. 4, the gamma correction resistors rQ1, rQ2, rQ62, and rQ63 are variable resistors that can control the resistance value with the correction signals Q1, Q2, Q62, and Q63, respectively. The gamma correction resistors rQ3 through rQ61 are fixed resistors.

Preferably, the gamma correction resistors 401 and the gamma correction resistors 403 that are provided between the same standard gray scale voltages are both variable resistors, or are both fixed resistors.

The operational amplifier 402 is coupled to the node 411 of the gamma correction resistor 401 and the node 413 of the gamma correction resistor 403, and outputs the standard gray scale voltage (VREF) from the gamma correction resistor 401 on an input side to the gamma correction resistor 403 on an output side. The operational amplifier 402 is a voltage follower implementing impedance conversion, and prevents the voltage drop due to current supply when the gray scale voltage is applied to the pixels.

The time during driving voltage is applied to liquid crystal is limited to selecting period (data start pulse (DSP) interval) for a pixel row of the liquid crystal. Accordingly, in the case where two input voltages are divided only by the resistance ratio of the resistors coupled to each other in series between the input voltages, it requires a long time to supply a current and voltage to the node for voltage of an intermediate part, which is distant from the input voltage, such that it becomes difficult to ensure the time for applying a given gray scale voltage to liquid crystal.

Thus, gamma correction resistors for dividing the input voltage so as to produce the standard gray scale voltages are provided on an input side, and gamma correction resistors for dividing the standard gray scale voltages are provided on an output side.

The initial resistance value (default or standard resistance value) of the variable resistor and the resistance value of the fixed resistor are determined depending on the gamma characteristic of a liquid crystal display. In this case, the resistance values between the same standard gray scale voltages are determined to be identical to each other. For example, between the standard gray scale voltages (REF1 through REF2, and V0 and V2), (initial resistance value of rP1)=(resistance value of rQ1)+(resistance value of rQ2) is satisfied.

Next, the case where the gamma correction circuit 400 shown in FIG. 4 is used for a liquid crystal display having a different gamma characteristic will be described.

In the case where the gamma correction circuit 400 constituted based on the gamma characteristic of a default liquid crystal display is used for another liquid crystal display having a different gamma characteristic, the setting of gray scale voltage output from the gamma correction circuit 400 is required to be changed.

Thus, the ratio of the gamma correction resistance on an input side is changed by adjusting the resistance values of the variable resistors rP1 and rP8 of the gamma correction resistors 401 on an input side with the correction signals P1 and P8 so as to change the standard gray scale voltages VREF (VREF1 through VREF9), and thereby the gray scale voltages Vx (V0 through V63) are changed.

Furthermore, with the correction signals Q1, Q2, Q3, and Q4, the resistance values of the variable resistors rQ1, rQ2, rQ62, and rQ63 of the gamma correction resistors 403 on an output side are changed to be the same resistance value, between the same standard gray scale voltages.

In this case, between the standard gray scale voltages VREF1 and VREF2 for example, (initial resistance value of rP1)=(initial resistance value of rQ1)+(initial resistance value of rQ2) is satisfied in the case where the gamma correction circuit 400 is mounted in a liquid crystal display having a default gamma characteristic. Meanwhile, even in the case where the circuit is mounted in a liquid crystal display having a gamma characteristic different from a default, (rP1+ΔrP1)=(rQ1+ΔrQ1)+(rQ2+ΔrQ2) (“Δ” means variation) is established by adjusting the gamma correction resistor rP1, and the gamma correction resistors rQ1 and rQ2 such that a potential difference is not caused between the nodes 411 and 413. Accordingly, overcurrent does not flow between the gamma correction resistor and the operational amplifier 402.

Thus, even in the case where the setting of the gray scale voltage is changed by changing the gamma correction resistor on an input side, the gamma correction resistor on an output side is changed at the same time, and thereby the potentials of an input side and an output side of the operational amplifier are kept identical to each other invariably, overcurrent therefore does not flow between the gamma correction resistor and the operational amplifier.

Accordingly, oscillation of the operational amplifier is prevented such that a stable gray scale voltage can be supplied. In addition, power consumption can be reduced.

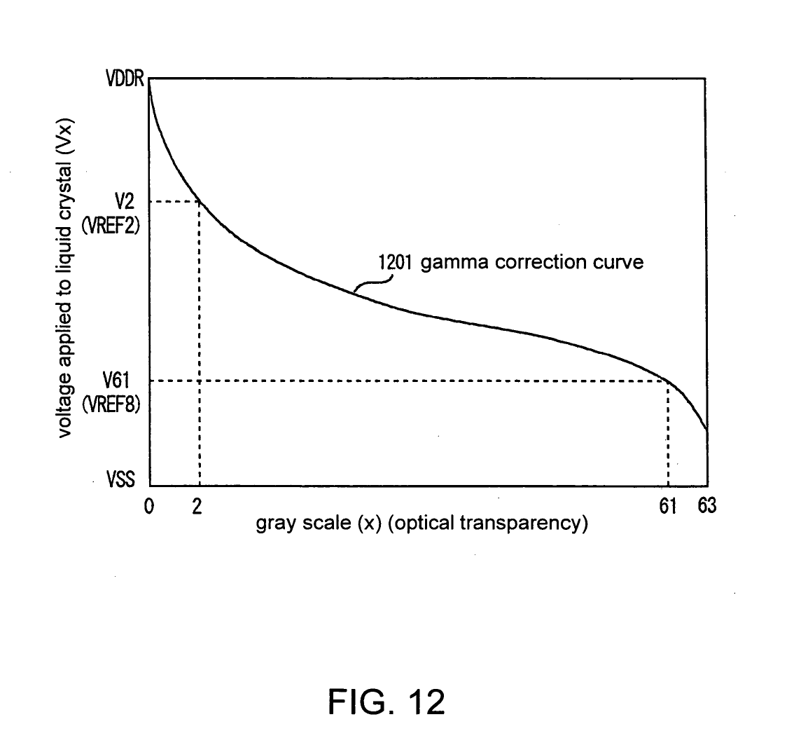

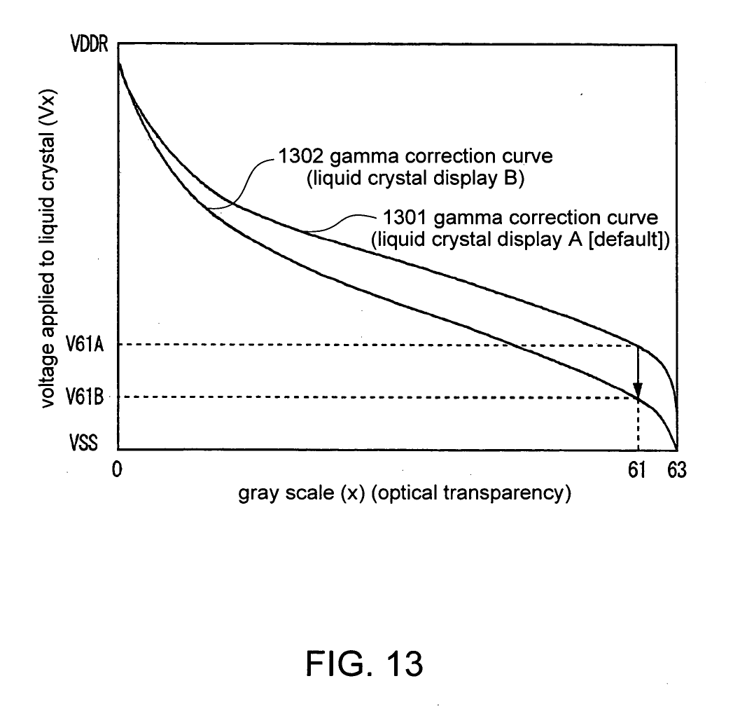

Referring to the gamma characteristic of the liquid crystal display shown in FIG. 12, a variation in the voltage applied to the liquid crystal (gray scale voltage) is small around the intermediate gray scale compared to around the edge gray scale, and thus the time until a current and voltage are supplied to the node outputting the gray scale voltage from the standard gray scale voltage is short.

Around the intermediate gray scale, therefore, more gamma correction resistors (output side) may be provided between the standard gray scale voltages compared to around the edge gray scale (in the vicinity of the input voltages VDDR and VSS, and in the vicinity of the gray scale voltages V0 and V63).

For example, gray scale voltages of three levels may be produced from between the standard gray scale voltages VREF1 and VREF2, which are in the vicinity of the edge gray scale, and gray scale voltages of six levels may be produced from between the standard gray scale voltages VREF5 and VREF6, which are in the vicinity of the intermediate gray scale.

Furthermore, referring to the gamma characteristic of the liquid crystal display show in FIG. 12, the gamma correction curve around the intermediate gray scale is more linear (straight line manner) compared to that around the edge gray scale (in the vicinity of input voltages VDDR and VSS, and in the vicinity of the gray scale voltages V0 and V63). Only the resistors of the edge gray scale part therefore may be variable resistors. Only the setting of the gray scale voltage around the edge gray scale, which is a non-linear part, is changed corresponding to a new gamma characteristic, and thereby the setting of the gray scale voltage around the intermediate gray scale, which is a linear part, is also changed along with the new gamma characteristic. Namely, the ratio of the gamma correction resistance around the intermediate gray scale, where the gamma characteristic is linear, need not be changed. In this case, compared to the case where all gamma correction resistors are variable resistors, the circuit arrangement can be simplified such that a cost burden and labor burden of manufacturing can be reduced.

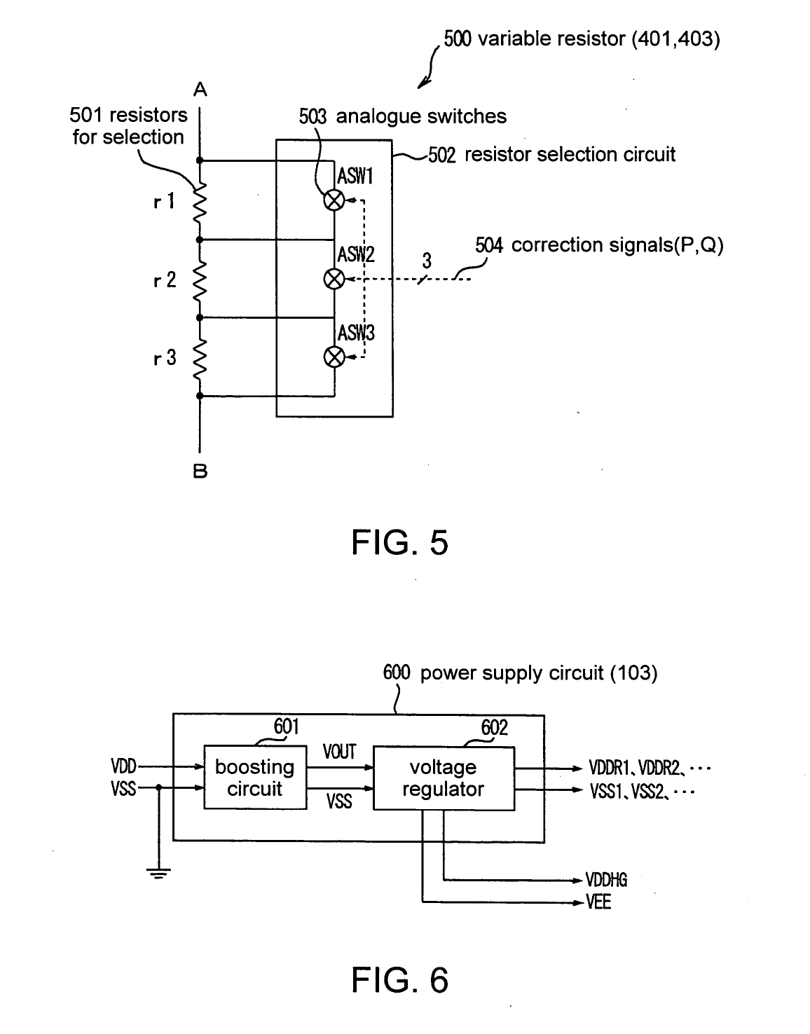

Variable resistors used for a gamma correction circuit will be described with reference to FIG. 5.

FIG. 5 is a diagram showing one embodiment of a variable resistor 500 (401 and 403).

Various resistors can be applied to the variable resistors as a gamma correction resistor in a gamma correction circuit. The variable resistors are not limited to the variable resistor 500 shown in FIG. 5.

The variable resistor 500 comprises resistors 501 for selection (r1 through r3) and a resistor selection circuit 502.

The resistor selection circuit 502 comprises analogue switches 503 (ASW1 through ASW3) that can be controlled with correction signals 504 (P and Q).

Referring to FIG. 5, the resistor selection circuit 502 includes three analogue switches 503. The ON and OFF state of the analogue switches 503 is controlled with the correction signals 504 of 3 (three) bits. In the case where the analogue switch ASW is “ON”, the relevant wiring is short-circuited. In the case of “OFF”, the resistor for selection is selected.

For example, in the case where the analogue switch ASW1 is “OFF”, the ASW2 is “ON”, and the ASW3 is “OFF”, the resistor r1 and the resistor r3 are selected between A and B.

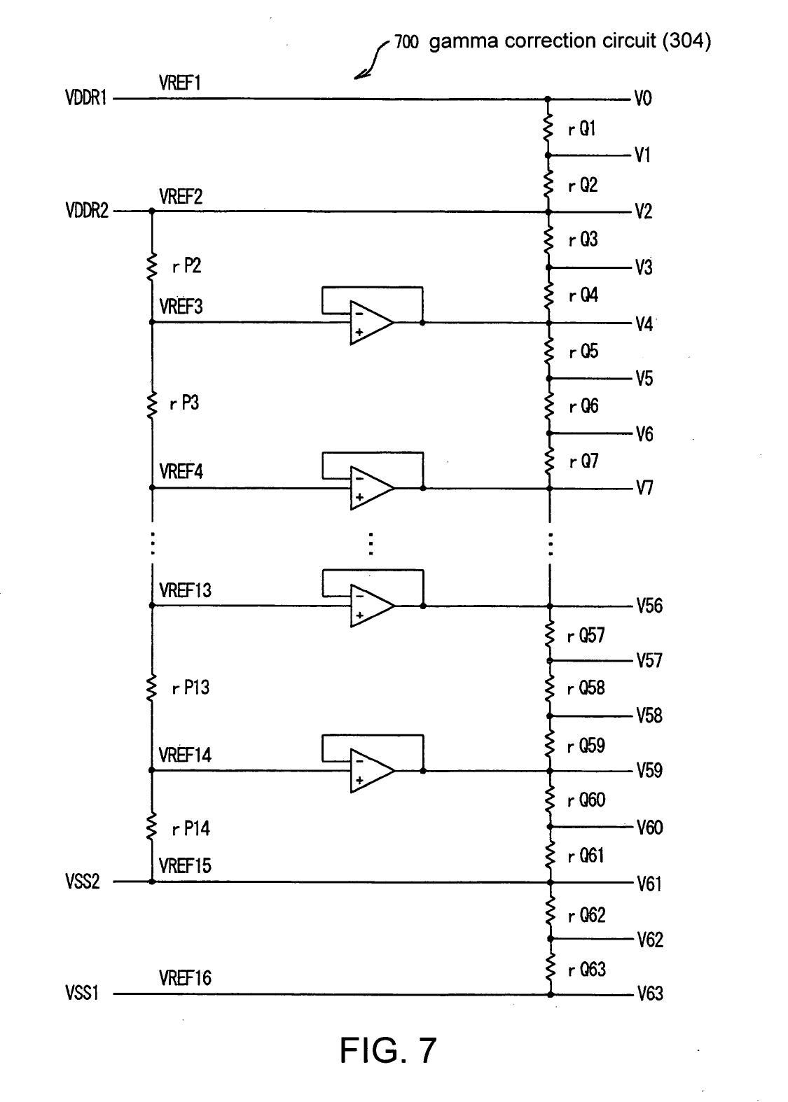

Gamma correction circuits according to other embodiments of the present invention will be described with reference to FIG. 6, and FIGS. 7 through 10.

FIG. 6 is a diagram schematically showing the structure of a power supply circuit 600 (103) according to another embodiment of the invention.

Although the power supply circuit 600 has the same structure as the power supply circuit described referring to FIG. 2, a voltage regulator 602 implements regulating when the boosted voltages VOUT and VSS are input thereto from a boosting circuit 601, so as to supply voltages of multiple kinds VDDR1, VDDR2, and so on, and voltages of multiple kinds VSS1, VSS2, and so on to gamma correction resistors of a gamma correction circuit, and supply the gate voltages VDDHG and VEE to the gate driver 105.

FIGS. 7 through 10 are diagrams schematically showing the structures of gamma correction circuits 700, 800, 900, and 1000 (304) according to another embodiments of the present invention.

Two input voltages (high potential side VDDR and low potential side VSS) are input to the gamma correction circuit 400 described referring to FIG. 4. Meanwhile, to the gamma correction circuits 700, 800, 900, and 1000, more input voltages (high potential side VDDR1, VDDR2, and so on, low potential side VSS1, VSS2, and so on) are input from the power supply circuit 600 shown in FIG. 6.

The explanation will be made on the premise that the gamma correction circuits 700, 800, 900, and 1000 produce the standard gray scale voltages VREF (VREF1 through VREF 16) from the input voltages (VDDR1, VDDR2, and so on, VSS1, VSS2, and so on) input from the power supply circuit 103, and further produce the gray scale voltages Vx (V0 through V63) from the standard gray scale voltages.

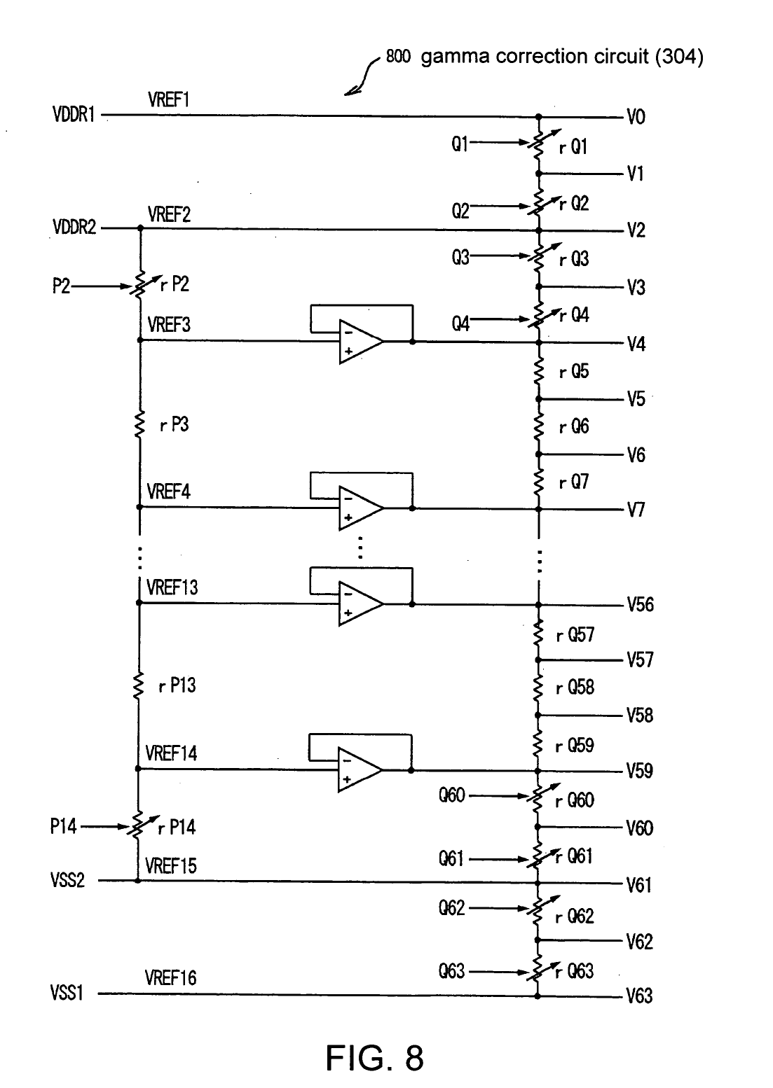

Four (4) input voltages (high potential side VDDR1 and VDDR2, and low potential side VSS1 and VSS2) are input to the gamma correction circuits 700 and 800 shown in FIGS. 7 and 8.

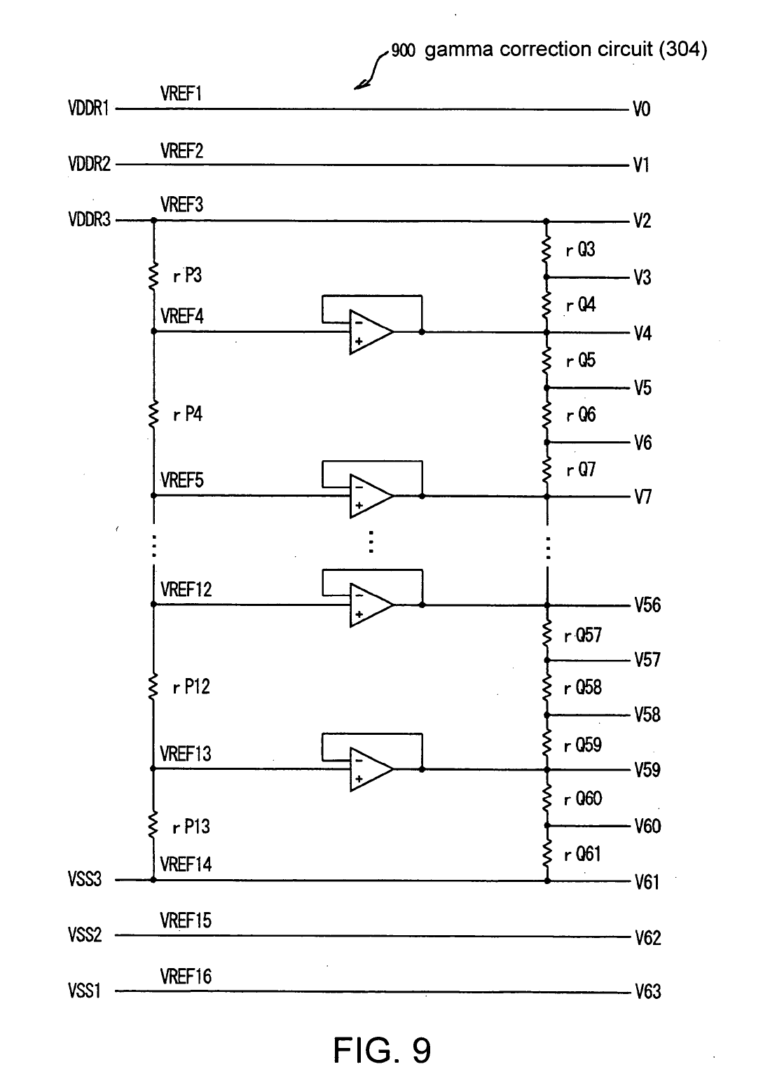

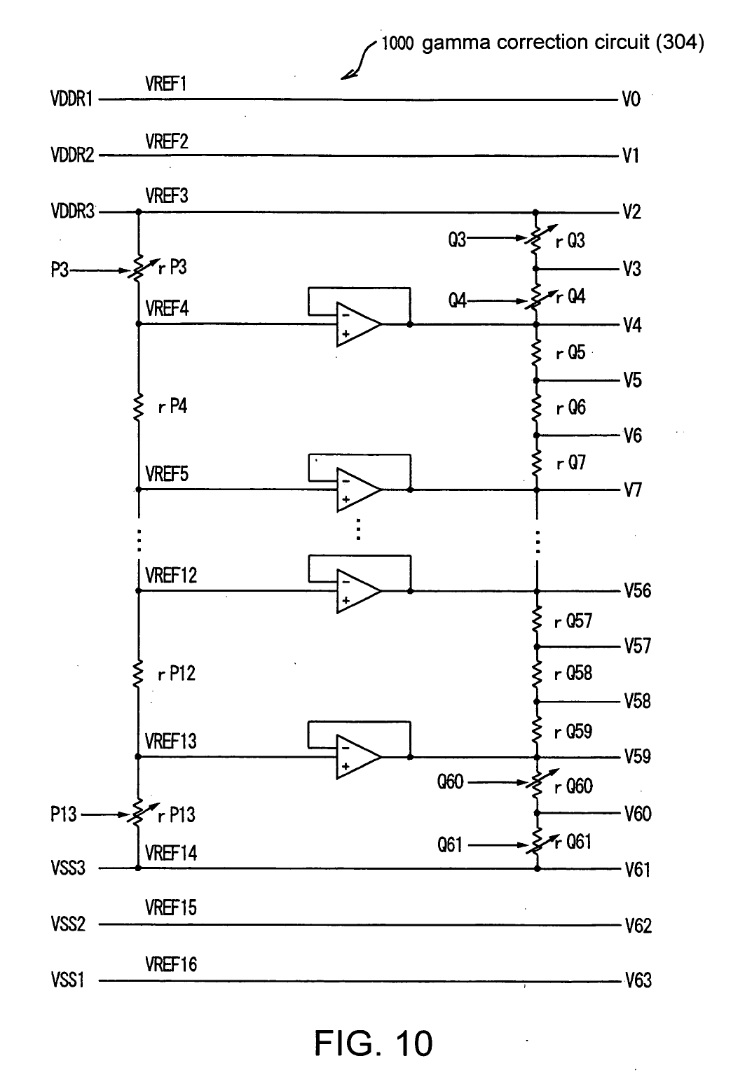

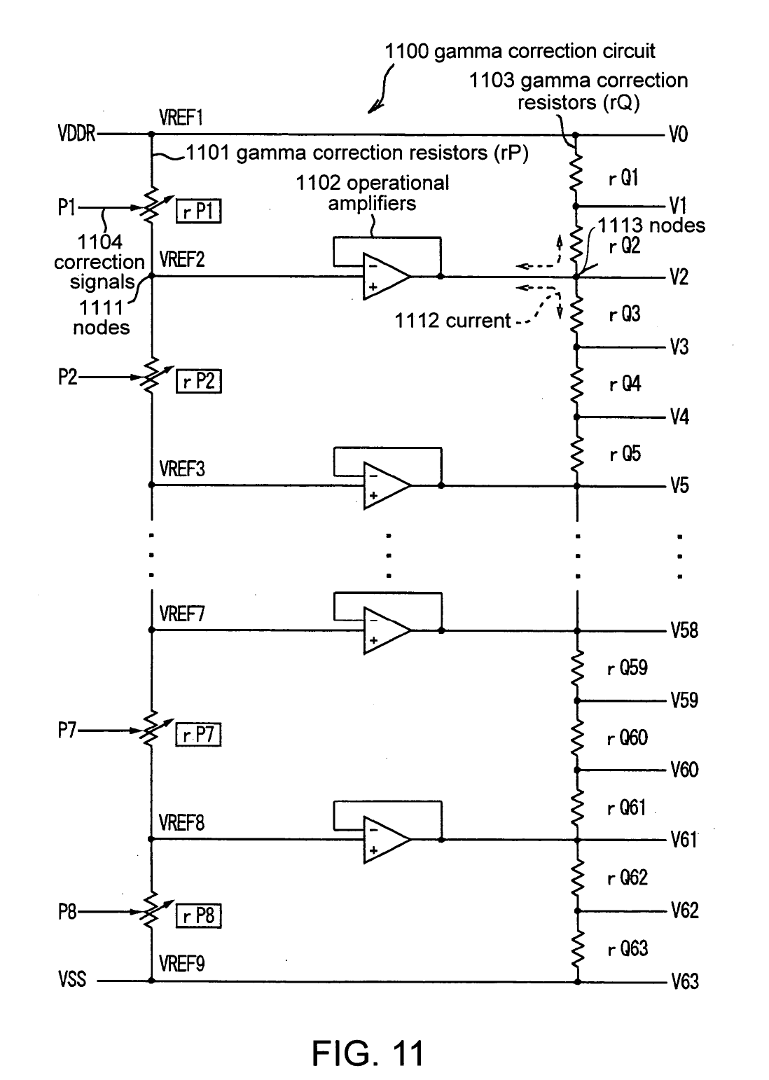

Six (6) input voltages (high potential side VDDR1, VDDR2, and VDDR3, and low potential side VSS1, VSS2, and VSS3) are input to the gamma correction circuits 900 and 1000 shown in FIGS. 9 and 10.

In the gamma correction circuit 700, the gamma correction resistors rP2 through rP14 on an input side are coupled to each other in series between the input voltages VDDR2 and VSS2, and the gamma correction resistors rQ1 through rQ63 on an output side are coupled to each other in series between the input voltages VDDR1 and VSS1.

Furthermore, in the gamma correction circuit 700, operational amplifiers are coupled that output the standard gray scale voltages VREF3 through VREF14, which are different from input voltage, from the gamma correction resistors on an input side to the gamma correction resistors on an output side.

In the gamma correction circuit 700, gamma correction resistors on an input side are not coupled between the input voltages VDDR1 and VDDR2, and between the input voltages VSS1 and VSS2.

Namely, in the gamma correction circuit 700, short circuits where input voltages other than input voltages for voltage dividing, among the plurality of input voltages, are used as the standard gray scale voltages are provided.

The resistance values between the same standard gray scale voltages are determined to be identical to each other. For example, between the standard gray scale voltages (REF2 and REF3, and V2 and V4), (resistance value of rP2)=(resistance value of rQ3)+(resistance value of rQ4) is satisfied.

In the case where the setting of the gray scale voltage is changed in the gamma correction circuit 700, the input voltages VDDR2 and VSS2 are changed by the power supply circuit 600. In this case, the settings of the standard gray scale voltage and the gray scale voltage can be changed without any change of the structure of the gamma correction circuit 700 itself.

The gamma characteristic around the intermediate gray scale is more linear (straight line manner) compared to that around the edge gray scale. Accordingly, when the input voltages VDDR2 and VSS2 are changed, the gray scale voltages (V1, V2, V61, V62, and so on) around the edge gray scale are changed according to a new gamma characteristic, at the same time the setting of the gray scale voltage around the intermediate gray scale is also changed along with the new gamma characteristic. Namely, the ratio of the gamma correction resistance around the intermediate gray scale, where the gamma characteristic is linear, need not be changed.

As the gamma correction circuit 800 shown in FIG. 8, all or part of the gamma correction resistors may be variable resistors.

For example, the gamma correction resistors rP2 and rP14 on an input side, the gamma correction resistors rQ1 through rQ4, rQ60 through rQ63 on an output side, may be variable resistors, and the other gamma correction resistors may be fixed resistors.

Preferably, the gamma correction resistors (rP) on an input side and the gamma correction resistors (rQ) that are provided between the same standard gray scale voltages are both variable resistors, or are both fixed resistors. Furthermore, it is preferable that the gamma correction resistors around the edge gray scale are variable resistors.

Thus, in the case where the gamma correction resistors around the edge gray scale are variable resistors, the setting of the gray scale voltage can be changed more precisely along with a new gamma characteristic.

As the gamma correction circuit 900 shown in FIG. 9, the gamma correction resistors may not be coupled on both an input side and an output side between the same standard gray scale voltages. Namely, short circuits where input voltages other than input voltages for voltage dividing, among the plurality of input voltages, are used as the gray scale voltage may be provided.

For example, between the standard gray scale voltages VREF1 and VREF2, VREF2 and VREF3, VREF14 and VREF15, and VREF15 and VREF16, the gamma correction resistor may not be coupled on both an input side and output side.

In this case, since the number of gamma correction resistors in a gamma correction circuit can be reduced, the circuit arrangement can be simplified such that a cost burden and manufacturing burden can be reduced. In addition, power consumption can be suppressed.

As the gamma correction circuit 1000 shown in FIG. 10, all or part of gamma correction resistors may be variable resistors.

For example, the gamma correction resistors rP3 and rP13 on an input side, and the gamma correction resistors rQ3, rQ4, rQ60, and rQ61 on an output side, may be variable resistors, and the other gamma correction resistors may be fixed resistors.

Preferably, the gamma correction resistors (rP) on an input side and the gamma correction resistors (rQ) that are provided between the same standard gray scale voltages are both variable resistors, or are both fixed resistors. Furthermore, it is preferable that the gamma correction resistors around the edge gray scale are variable resistors.

Thus, in the case where the gamma correction resistors around the edge gray scale are variable resistors, the setting of the gray scale voltage can be changed more precisely along with a new gamma characteristic.

The gamma correction circuit of the present invention is not limited to the above described embodiments but can apply to various modifications.

The above embodiments have been described on the premise that a gamma correction circuit controls a gray scale voltage of 64 (sixty-four) gray scales (6 bits). The gamma correction circuit, however, is not limited to this but can be applied to other gray scale numbers (bit numbers).

A gamma correction circuit may be formed integrally with a source driver on the same substrate, or may be formed independently on a substrate different from that of the source driver.

Although a liquid crystal display is disclosed as a display where a gamma correction circuit is provided in the above embodiment, a display is not limited to this. The gamma correction circuit according to the present invention can be used for other displays such as a plasma display panel (PDP), an EL display (Electro Luminescent Display), and an electronic paper display, for example.

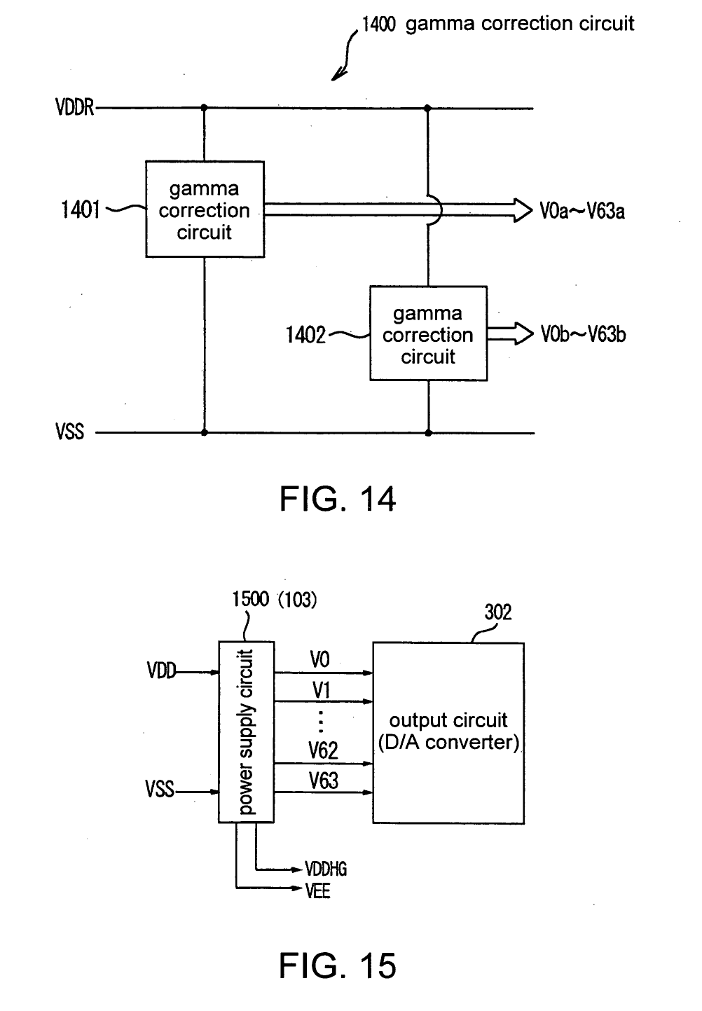

In addition, the gamma correction circuit may be brought to correspond with polarity inversion for alternating. For example, in the case of 64 (sixty-four) gray scales (6 bits), gray scale voltages of 64 (sixty-four) levels×2 (two) sets may be produced as shown in FIG. 14.

FIG. 14 is a diagram showing one embodiment of a gamma correction circuit 1400 outputting gray scale voltages of two sets.

The gamma correction circuit 1400 comprises a gamma correction circuit 1401 and a gamma correction circuit 1402.

The gamma correction circuit 1401 outputs gray scale voltages V0a through V63a from input voltages (VDDR and VSS). The gamma correction circuit 1402 outputs gray scale voltages V0b through V63b from input voltages (VDDR and VSS). Namely, the gamma correction circuit 1400 outputs gray scale voltages of 64 (sixty-four) levels×2 (two) sets (V0a through V63a, and V0b through V63b).

As the gamma correction circuit 1401 and the gamma correction circuit 1402, the above gamma correction circuits 400, 700, 800, 900 and 1000 can be used.

Instead of voltage dividing in a gamma correction circuit, all of the gray scale voltages may be produced on a power supply circuit side as shown in FIG. 15.

FIG. 15 is a diagram showing one embodiment of a power supply circuit 1500 producing all gray scale voltages.

The power supply circuit 1500 regulates boosted voltage produced in a boosting circuit with a voltage regulator so as to produce all gray scale voltages corresponding to a gamma characteristic. For example, in the case where the output circuit 302 (D/A converter) of the source driver 104 requires gray scale voltages of 64 (sixty-four) gray scales (6 bits), the power supply circuit 1500 produces gray scale voltages over all 64 (sixty-four) gray scales so as to supply them to the output circuit of the source driver.

In this case, there is no need to provide a gamma correction circuit.

Although the preferred embodiments of the gamma correction circuit according to the present invention have been described above with reference to accompanying drawings, the invention is not limited to the embodiments. It will be apparent that those skilled in the art can consider various changes or modifications within the technical ideas disclosed in the present application, and these changes or modifications are construed as being within the technical scope of the invention.

Advantageous Effects of the Invention

As described above in detail, according to the present invention, a gamma correction circuit is provided that can be compatible with various gamma characteristics, and can supply stable gray scale voltages while suppressing power consumption.

1. A gamma correction circuit dividing an input voltage so as to produce a plurality of standard gray scale voltages and further dividing the standard gray scale voltages so as to output a plurality of gray scale voltages, comprising:
a plurality of first resistors producing the standard gray scale voltages at each node and including at least one variable resistor;
a plurality of second resistors producing the gray scale voltages at each node and including at least one variable resistor; and
at least one voltage follower outputting the standard gray scale voltages input from a side of the first resistors to a side of the second resistors.

2. The gamma correction circuit according to claim 1 wherein the first resistors are coupled to each other in series between a high potential side of the input voltage and a low potential side of the input voltage.

3. The gamma correction circuit according to claim 1 wherein the second resistors are coupled to each other in series between the standard gray scale voltages.

4. The gamma correction circuit according to claim 1 wherein the first resistors and the second resistors that are provided between the same standard gray scale voltages are both one of variable resistors and fixed resistors.

5. The gamma correction circuit according to claim 1, wherein:
the first resistors and the second resistors that are provided between the same standard gray scale voltages are both one of variable resistors and fixed resistors; and
the variable resistors are controlled so that the resistance value of the first resistors and the resistance value of the second resistors are identical to each other between the same standard gray scale voltages.

6. The gamma correction circuit according to claim 1 wherein the first resistors and the second resistors in the vicinity of the input voltage are variable resistors and the remaining first resistors and second resistors are fixed resistors.

7. The gamma correction circuit according to claim 1, wherein:
the input voltage includes a plurality of input voltages; and
at least one short circuit where input voltages other than input voltages for voltage dividing, among the plurality of input voltages, are used as one of the standard gray scale voltages and the gray scale voltages is provided.

8. The gamma correction circuit according to claim 1 wherein the variable resistors include a resistor selection circuit controlled with a correction signal and selecting a resistor.

9. A liquid crystal driving circuit, comprising:
the gamma correction circuit according to claim 1.

10. A display, comprising:
the gamma correction circuit according to claim 1.

11. A power supply circuit producing gray scale voltage for selection throughout all gray scales and supplying the gray scale voltage to an output circuit that digital to analog converts display data so as to output driving voltage to an electrode.

12. A liquid crystal driving circuit, comprising:
the power supply circuit according to claim 11.

13. A display, comprising:
the power supply circuit according to claim 11.
